(19) United States
(12) Patent Application Publication
(10) Pub. No.: US 2011/0138110 A1
(43) Pub. Date: Jun. 9, 2011

(54) METHOD AND CONTROL UNIT FOR PERFORMING STORAGE MANAGEMENT UPON STORAGE APPARATUS AND RELATED STORAGE APPARATUS

(76) Inventor: Chao-Yin Liu, Hsinchu City (TW)

(21) Appl. No.: 12/721,543

(22) Filed: Mar. 10, 2010

(30) Foreign Application Priority Data
Dec. 7, 2009 (TW) 098141686

(51) Int. Cl. G06F 12/00; G06F 12/02

(52) U.S. Cl. 711/103; 711/E12.001; 711/E12.008

(57) ABSTRACT

A storage apparatus has a first storage unit and a second storage unit. A method for performing storage management upon the storage apparatus includes: storing an input data into the first storage unit; and, while the input data is being stored into the first storage unit, checking whether the input data is continuous, wherein a portion of the input data which is not stored into the first storage unit yet will be stored into the first storage unit if the input data is found to be continuous, and the portion of the input data which is not stored into the first storage unit yet will be stored into the second storage unit if the input data is found to not be continuous.

### BACKGROUND OF THE INVENTION

1. Field of the Invention

The present invention relates to data storage, and more particularly, to a storage method and related control unit for a storage apparatus (e.g. solid state disk).

2. Description of the Prior Art

In recent times, solid state disks (SSD) have been widely adopted in PCs or laptops. The SSD is a data storage device that consists of flash memories. With different types of flash memories, different SSDs have different hardware costs and performances. Most SSDs consist of either single-level cell (SLC) flash memories or multi-level cell (MLC) flash memories. These two different flash memories each have their own advantages. The SLC flash memory has faster read/write speeds and a longer service life while the MLC flash memory is much cheaper. Thus, to meet a balance between the hardware cost and the performance, manufacturers have provided a hybrid SSD that consists of both MLC and SLC flash memories. In the conventional art, however, there is no effective and proper manner for managing the hybrid SSD. That is, there are many deficiencies still existing in the conventional SSD that need to be improved.

### SUMMARY OF THE INVENTION

For improving the deficiencies of the conventional art, the present invention provides a storage management method and a related control unit for managing the hybrid SSD. Further, the present invention provides an inventive hybrid SSD having a storage management function based on the concept of inventive storage management.

As far as the hardware cost is concerned, the cheaper MLC flash memory is preferred. Thus, a hybrid SSD usually comprises significantly more MLC flash memories than SLC flash memories. Thus, how to use the limited SLC flash memories is the main concern. The major concept of the present invention is to allocate data according to the continuity of the data and the utilization frequency of the data. For example, data that is continuous is stored in the slower MLC flash memories and data that is not continuous is stored in the faster SLC flash memories, thereby balancing the write/read speed difference between the continuous data and non-continuous data. Moreover, according to the update frequencies of data blocks, the present invention observes the utilization frequency of the data stored in the data b lock. Accordingly, the present invention moves the stored data which is frequently accessed to data blocks of the faster SLC flash memory, thereby improving the write/read performance of the hybrid SSD.

According to one exemplary embodiment of the present invention, a storage management method for a storage apparatus is provided. The storage apparatus has a first storage unit and a second storage unit. The storage management method comprises: storing input data into the first storage unit; and checking whether the input data has continuity while the input data is being stored into the first storage unit; if the input data has continuity, storing a portion of the input data that has not been stored into the first storage unit into the first storage unit, and if the input data does not have continuity, storing the portion of the input data that has not been stored into the first storage unit into the second storage unit.

Preferably, the first storage unit and the second storage unit respectively have a plurality of blocks, and the storage management method further comprises: when a first stored data stored in a first specific block of the first storage unit is to be merged with a second stored data stored in a second specific block of the first storage unit in order to be written into a third specific block, selecting a block as the third specific block from either the first storage unit or the second storage unit according to whether the first stored data has continuity.

Preferably, the block is selected from the second storage unit as the third specific block when the first stored data does not have continuity; and the block is selected from the first storage unit as the third specific block when the first stored data has continuity.

Preferably, the first storage unit and the second storage unit respectively have a plurality of blocks, and the storage management method further comprises: when a block adjustment operation is performed upon a first specific block of the second storage unit, determining whether to replace the first specific block with a second specific block of the first storage unit for storing the data originally stored in the first specific bloc according to a specific condition of the utilization status of the first specific block.

According to another exemplary embodiment of the present invention, a control unit utilized in a storage apparatus for performing storage management is provided. The storage apparatus has a first storage unit and a second storage unit. The control unit comprises: a first processing circuit and a second processing circuit. The first processing circuit is utilized for controlling data accesses to the storage apparatus. While the first processing circuit stores an input data into the first storage unit, the second processing circuit is utilized for checking whether the input data has continuity; if the input data has continuity, the first processing circuit stores a portion of the input data that has not been stored into the first storage unit into the first storage unit, and if the input data does not have continuity, the first processing circuit stores the portion of the input data that has not been stored into the first storage unit into the second storage unit.

Preferably, the first storage unit and the second storage unit controlled by the control unit respectively have a plurality of blocks, and when a first stored data stored in a first specific block of the first storage unit is to be merged with a second stored data stored in a second specific block of the first storage unit in order to be written into a third specific block by the first processing unit, the first processing circuit further selects a block as the third specific block from either the first storage unit or the second storage unit according to whether the first stored data has continuity.

Preferably, the first processing circuit selects the block from the second storage unit as the third specific block when the first stored data does not have continuity, and the first processing circuit selects the block from the first storage unit as the third block when the first stored data has continuity.

Preferably, the first storage unit and the second storage unit controlled by the control unit respectively have a plurality of blocks, and when the first processing circuit performs a block adjustment operation upon a first specific block of the second storage unit, the first processing circuit further determines whether to replace the first specific block with a second specific block of the first storage unit for storing the data originally stored in the first specific block according to a specific condition of the utilization status of the first specific block.

According to still another exemplary embodiment of the present invention, a storage apparatus is provided. The storage apparatus comprises: a first storage unit, a second storage unit, and a control unit. The control unit comprises a first processing circuit and a second processing circuit. The first processing circuit is utilized for controlling data access to the storage apparatus. While the first processing circuit stores an input data into the first storage unit, the second processing circuit is utilized for checking whether the input data has continuity; if the input data has continuity, the first processing circuit stores a portion of the input data that has not been stored into the first storage unit into the first storage unit, and if the input data does not have continuity, the first processing circuit stores the portion of the input data that has not been stored into the first storage unit into the second storage unit.

Preferably, the first storage unit and the second storage unit controlled by the control unit respectively have a plurality of blocks, and when a first stored data stored in a first specific block of the first storage unit is to be merged with a second stored data stored in a second specific block of the first storage unit in order to be written into a third specific block by the first processing unit, the first processing circuit further selects a block as the third specific block from either the first storage unit or the second storage unit according to whether the first stored data has continuity.

Preferably, the first processing circuit selects the block from the second storage unit as the third specific block when the first stored data does not have continuity, and the first processing circuit selects the block from the first storage unit as the third block when the first stored data has continuity.

Preferably, the first storage unit and the second storage unit controlled by the control unit respectively have a plurality of blocks, and when the first processing circuit performs a block adjustment operation upon a first specific block of the second storage unit, the first processing circuit further determines whether to replace the first specific block with a second specific block of the first storage unit for storing the data originally stored in the first specific block according to a specific condition of the utilization status of the first specific block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart according to one exemplary embodiment of the present invention.

FIG. 2 is a block diagram showing a control unit and a storage apparatus according to one exemplary embodiment of the present invention.

### DETAILED DESCRIPTION

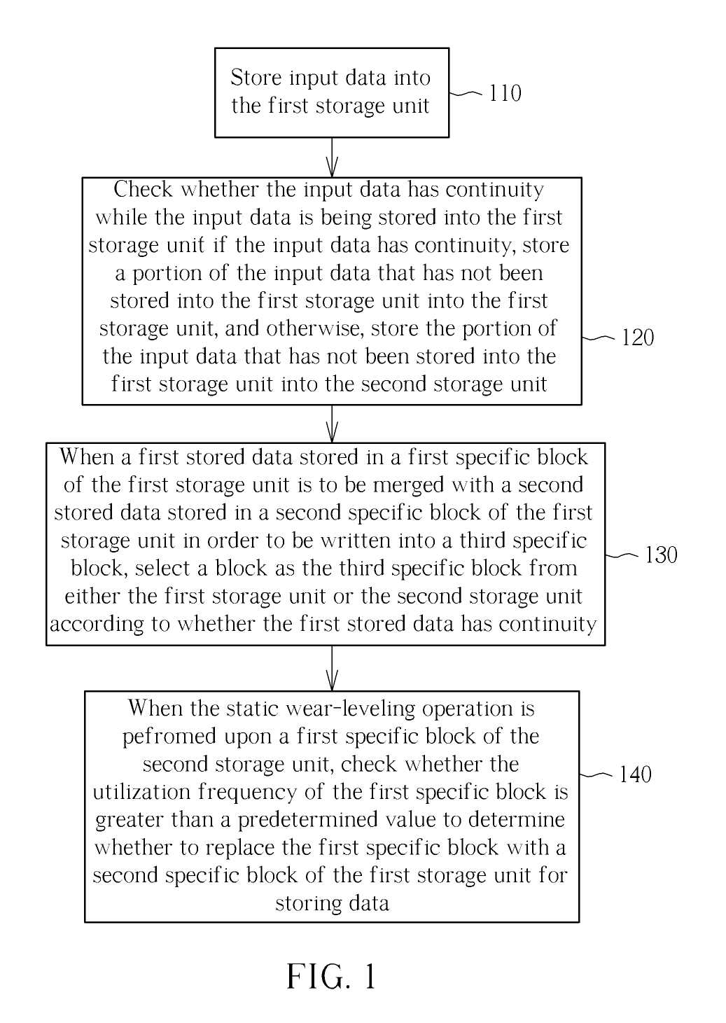

Please refer to FIG. 1, which illustrates a flow chart according to one exemplary embodiment of the inventive storage management method. Each step shown in FIG. 1 respectively explains how to determine to store an input data from a host (not shown) into either a first storage unit (e.g. MLC flash memory) of a storage apparatus or into a second storage unit (e.g. SLC flash memory) of a storage apparatus. Firstly, in Step 120, when each sector/block data of the input data is gradually stored into the first storage unit, the input data is checked to see whether it has continuity (e.g. whether logical addresses corresponding to each sector/block data are continuous), in order to determine whether to continue storing the remaining data that has not yet been stored into the first storage unit, or to store the remaining data that has not yet been stored into the second storage unit. For example, if a portion of the data that has not been stored has continuity, the portion of the data that has not been stored is still to be stored into the first storage unit; contrarily, if the portion of the input data that has not been stored does not have continuity, the portion of the input data is to be stored into the second storage unit. That is, the major concept of the inventive storage management method is to store the input data which has continuous logical addresses into the MLC flash memory, whereas input data which does not have continuous logical addresses is stored into the SLC flash memory. That is, the reading/writing speed difference between the SLC and MLC flash memories can make up for the different reading/writing times needed by continuous data and non-continuous data. In another exemplary embodiment of the present invention, however, it is feasible to store the input data into the second storage unit, and then, depending on the continuity of the input data, it is determined whether to store the remaining portion of the input data into the second storage unit or into the first storage unit. Both of the above-mentioned exemplary embodiments can eventually store the data that has continuous logical addresses into the first storage unit (e.g. MLC flash memory) and store the data that does not have continuous logical addresses into the second storage unit (e.g. SLC flash memory). Both these embodiments fall within the scope of the present invention.

In this exemplary embodiment, all available storage space in the first and the second storage unit is divided into a plurality of data blocks and a plurality of log blocks. When the data is written, each data is firstly stored into a data block. However, if the following data to be written is to update the stored data, the content of the following for updating the stored data will be stored into a log block corresponding to the data block. Accordingly, after a period of time where a lot of data is written, a relationship between the data blocks and the log blocks will be established. This relationship involves the translation between logical addresses and physical addresses, which is well known to a person skilled in the art. For the sake of brevity, detailed descriptions about this relationship are omitted here. In short, in most cases, when the input data is stored, the input data cannot be directly written into data blocks; instead, the input data is only allowed to be written into log blocks. Thus, when the amount of log blocks is not enough for storing more input data, the data originally stored in the data block will be merged with the data stored in a corresponding log block corresponding to the data block (i.e., the above-mentioned relationship) and the merged data will be stored into another new data block. Then, the data originally in the data block and the log block can be erased so that the log block can store new input data.

In the step 130, the inventive storage management method determines to store a merged data into either a data block of the first storage unit or a data block of the second storage unit according to whether the logical addresses corresponding to the stored data that is to be merged and stored in the log block has continuity. For example, if the data in a log block of the second storage unit is to be merged with the data in a corresponding data block of the second storage unit, and the data in the log block has continuity, the present invention selects an available data block from the first storage unit to store the merged data. If the data in a log block of the first storage unit is to be merged with the data in a corresponding data block of the first storage unit, and the data stored in the log block does not have continuity, the present invention selects an available data block from the second storage unit to store the merged data. More clearly, if the data in the log block has continuity, the present invention selects the data block from the first storage unit to store the merged data; otherwise, the present invention selects the data block from the second storage unit to store the merged data. Which storage unit the log block belongs to is irrelevant to the selection of the data block. As can be seen from operations in Steps 110-130, the inventive method intends to ensure that the data that has continuity is stored into the first storage unit while the data that does not have continuity is stored into the second storage unit. By these operations, each portion of the input data is properly stored into either the first storage unit or the second storage unit depending on the continuity of logical addresses of each portion of the input data, thereby finely classifying the continuity of each portion of the input data.

Then, after the data stored in the storage unit is updated and read many times, according to the utilization frequency of the stored data, the inventive storage management method adjusts the location where the stored data is stored. For example, the inventive storage management method determines whether to move a stored data in a data block of the second storage unit to be stored in a data block of the first storage unit according to the access times of the data block where the stored data is originally stored, which is the secondary concept of the present invention: determining the location where the data is stored according to the utilization frequency of the data by an adjustment operation.

The present invention aims to reduce the loading of the control unit when the above-mentioned adjustment operation is performed. Thus, this adjustment operation is performed at the time when the static wear-leveling operation is performed. For example, if a certain data block meets the condition to trigger the static wear-leveling operation (for example, an erase count of the data block is greater than an averaged erase count of all data blocks), the static wear-leveling operation selects a replacement data block from all the data blocks to replace the original data block, and the data stored in the original data block is moved into the selected replacement data block. When the static wear-leveling operation is performed, the inventive adjustment operation utilizes this timing to check the utilization frequency of the data block or the number of times that the original data block is accessed, in order to determine to select the replacement data block from either the first storage unit or the second storage unit. Hence, in Step 140, it is checked whether the utilization frequency of the data block of the second storage unit that is to be processed by the static wear-leveling operation is greater than a predetermined value. If yes, the inventive storage management method selects the replacement block from the second storage unit for storing the data originally stored in the original data block; otherwise, the inventive storage management method selects the replacement block from the first storage unit for storing the data originally stored in the original data block. By this adjustment operation, the space in which the data is stored can be adjusted in accordance with the utilization frequency of the data. As a result, the data that are frequently accessed will be stored in the second storage unit, thereby improving the writing/reading performance of the storage apparatus. As the service life of the second storage unit is relatively longer than that of the first storage unit, storing data which is frequently accessed into the second storage unit can reduce the potential for malfunction of the storage apparatus and increase the reliability of the storage apparatus. It should be especially noted that, although it is described above that the inventive storage management method performs this adjustment operation while the data block of the second storage unit is processed by the static wear-leveling operation, it also falls within the scope of the present invention to perform this adjustment operation while the data block of the first storage unit is processed by the static wear-leveling operation. That is, the inventive adjustment operation determines the replacement block of the static wear-leveling operation.

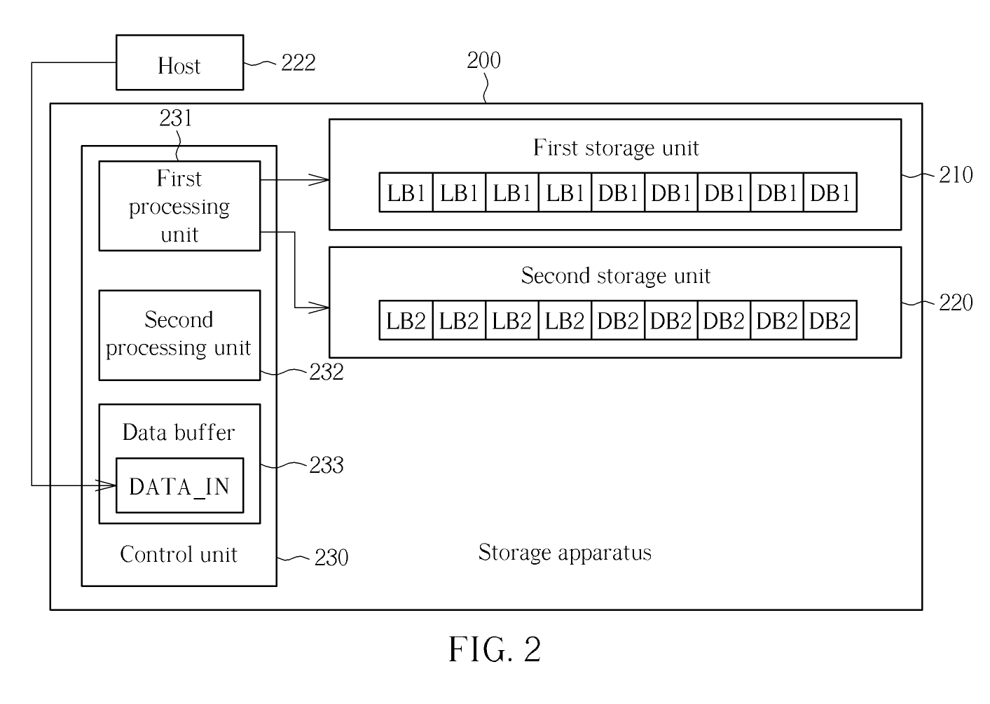

In accordance with the concept of the inventive storage management method, the present invention further provides a control unit and a storage apparatus having this storage management function. Please refer to FIG. 2, which illustrates a block diagram according to one exemplary embodiment of the present invention. As shown in FIG. 2, a storage apparatus includes a first storage unit 210, a second storage unit 220 and a control unit 230. In this exemplary embodiment, the storage apparatus is a solid state disk, the first storage unit 210 is an MLC flash memory and the second storage unit 220 is a an SLC flash memory. The first storage unit 210 includes a plurality of data blocks DB1 and a plurality of log blocks LB1. Also, the second storage unit 220 includes a plurality of data blocks DB2 and a plurality of log blocks LB2. As shown in FIG. 2, the control unit 230 includes a first processing unit 231, a second processing unit 232, and a data buffer 233. Please note that, in this exemplary embodiment, the data buffer 233 is embedded in the control unit 230. In other exemplary embodiments of the present invention, however, the data buffer 233 may be externally coupled to the control unit 230 or incorporated into the first processing circuit 231. Additionally, the storage apparatus 200 is coupled to a host 222, and performs data read operations or data write operations according to commands, addresses and data sent by the host 222. When the host 222 intends to store input data DATA_IN into the storage apparatus 200, the input data DATA_IN is temporarily stored in the data buffer 223, and then the input data DATA_IN is gradually stored into the first storage unit 210 or the second storage unit 220 by the first processing circuit 231. In one exemplary embodiment, the first processing circuit 231 stores the input data DATA_IN into the first storage unit 210. While the input data DATA_IN is being stored into the first storage unit 210, the second processing circuit 232 checks the continuity of the input data DATA_IN to determine whether to continuing storing the remaining part of the input data DATA_IN into the first storage unit 210 or change to store the remaining part of the input data DATA_IN into the second storage unit 220. At this time, the control unit 230 preliminarily classifies the input data DATA_IN in accordance with the continuity.

Then, when the host 222 repeatedly updates the data stored in the storage apparatus 220, it does not directly edit/change the data stored in the data blocks DB1 or DB2; instead, the data for updating the stored data is stored into log blocks LB1 or LB2. Additionally, the relationship between the data blocks and the corresponding log blocks will be recorded in the data buffer 233. When the number of the log blocks LB1 or LB2 is insufficient, the first processing circuit 231 of the control unit 230 performs a block merge operation to merge the data in the data block with the data in the corresponding log block according to the relationship recorded in the data buffer 233. The first processing circuit 231 selects an available data block from either the first storage unit 210 or the second storage unit 220 to store the merged data, and then erases the data originally stored in the data block and the log block. In the meantime, the first processing circuit 231 determines to select a writable data block from either the first storage unit or the second storage unit according to whether the data stored in the log block has continuity. When the data stored in the log block has continuity, the first processing circuit 231 selects the data block from the first storage unit 210; otherwise, the first processing circuit 231 selects the data block from the second storage unit 220. As a result, by this operation, the data in the storage apparatus 200 is more delicately classified based on the data continuity.

When the first processing circuit 231 is meant to perform a static wear-leveling operation upon one data block DB2 of the second storage unit, the first processing circuit 231 determines whether the data stored in the data block DB2 is frequently accessed according to the access times of the data block DB2 or the utilization frequency of the data block DB2. If a number of times that the data block DB2 is accessed is greater than a predetermined value, it means that the data currently stored in the data block DB2 has a high utilization frequency, and maintaining this data in the second storage unit 220 can improve the performance of the storage apparatus 220. Thus, the first processing circuit 231 still selects an available data block from other data blocks DB2 for storing the data. If a number of times that the data block DB2 is accessed is smaller than a predetermined value, it means that the data currently stored in the data block DB2 has a low utilization frequency. Accordingly, the first processing circuit 231 further selects an available data block from the data blocks DB1 for storing the data. Thus, the inventive storage apparatus can utilize the advantages of different storage units, and manages the stored data so that the performance and the service life of the storage apparatus can be improved.

Based on the concept and the spirit of the present invention, the inventive storage management method and control unit can be broadly applied to any storage apparatus comprising different types of flash memories having different write/read speeds. In other words, according to the above description, the inventive storage management method can balance the speed difference between two different storage units. Thus, the inventive storage management method and control unit can easily be applied to the storage apparatus having flash memories of different write/read speeds. Furthermore, due to the miniaturization of the semiconductor, the flash memory decreases in size and area. However, this trend leads to the slow write/read speed of the flash memory. Thus, in the future, the manufacturer may fabricate the hybrid solid state disk with one type of flash memory (e.g. all are MLC or all are SLC) but these are fabricated with processes of different sizes (e.g. 90 nm and 45 nm). This kind of hybrid solid state disk can still be controlled by the inventive storage management method and control unit. The inventive storage management method and control unit can also control the storage apparatus having storage units of different service life.

Those skilled in the art will readily observe that numerous modifications and alterations of the device and method may be made while retaining the teachings of the invention.

What is claimed is:

1. A storage management method for a storage apparatus, the storage apparatus having a first storage unit and a second storage unit, the storage management method comprising:
storing input data into the first storage unit; and
checking whether the input data has continuity while the input data is being stored into the first storage unit; if the input data has continuity, storing a portion of the input data that has not been stored into the first storage unit into the first storage unit, and if the input data does not have continuity, storing the portion of the input data that has not been stored into the first storage unit into the second storage unit.

2. The storage management method of claim 1, wherein the first storage unit is a multi-level cell storage unit and the second storage unit is a single-level cell storage unit.

3. The storage management method of claim 1, wherein the first storage unit and the second storage unit respectively have a plurality of blocks, and the storage management method further comprises:
when a first stored data stored in a first specific block of the first storage unit is to be merged with a second stored data stored in a second specific block of the first storage unit in order to be written into a third specific block, selecting a block as the third specific block from either the first storage unit or the second storage unit according to whether the first stored data has continuity.

4. The storage management method of claim 3, wherein the step of selecting the block as the third specific block from either the first storage unit or the second storage unit according to whether the first stored data has continuity comprises:
selecting the block from the second storage unit as the third specific block when the first stored data does not have continuity; and
selecting the block from the first storage unit as the third specific block when the first stored data has continuity.

5. The storage management method of claim 3, wherein the first specific block is a log block.

6. The storage management method of claim 1, wherein the first storage unit and the second storage unit respectively have a plurality of blocks, and the storage management method further comprises:
when a block adjustment operation is performed upon a first specific block of the second storage unit, determining whether to replace the first specific block with a second specific block of the first storage unit for storing the data originally stored in the first specific block according to a specific condition of the utilization status of the first specific block.

7. The storage management method of claim 6, wherein the block adjustment operation is a wear-leveling operation.

8. The storage management method of claim 7, wherein the specific condition is a utilization frequency of the first specific block.

9. The storage management method of claim 1, wherein the storage apparatus is a solid state disk, and the first and the second storage unit are flash memories.

10. The storage management method of claim 1, wherein the write/read speed of the second storage unit is higher than that of the first storage unit.

11. The storage management method of claim 1, wherein the service life of the second storage unit is longer than that of the first storage unit.

12. A control unit utilized in a storage apparatus for performing storage management, the storage apparatus having a first storage unit and a second storage unit, the control unit comprising:
a first processing circuit, for controlling data access to the storage apparatus; and
a second processing circuit, for checking whether the input data has continuity while the first processing circuit stores an input data into the first storage unit; if the input data has continuity, the first processing circuit stores a portion of the input data that has not been stored into the first storage unit into the first storage unit, and if the input data does not have continuity, the first processing circuit stores the portion of the input data that has not been stored into the first storage unit into the second storage unit.

13. The control unit of claim 12, wherein the first storage unit and the second storage unit controlled by the control unit respectively have a plurality of blocks, and when a first stored data stored in a first specific block of the first storage unit is to be merged with a second stored data stored in a second specific block of the first storage unit in order to be written into a third specific block by the first processing unit, the first processing circuit further selects a block as the third specific block from either the first storage unit or the second storage unit according to whether the first stored data has continuity.

14. The control unit of claim 13, wherein the first processing circuit selects the block from the second storage unit as the third specific block when the first stored data does not have continuity, and the first processing circuit selects the block from the first storage unit as the third block when the first stored data has continuity.

15. The control unit of claim 12, wherein the first storage unit and the second storage unit controlled by the control unit respectively have a plurality of blocks, and when the first processing circuit performs a block adjustment operation upon a first specific block of the second storage unit, the first processing circuit further determines whether to replace the first specific block with a second specific block of the first storage unit for storing the data originally stored in the first specific block according to a specific condition of the utilization status of the first specific block.

16. The control unit of claim 15, wherein the block adjustment operation is a wear-leveling operation.

17. The control unit of claim 16, wherein the specific condition is a utilization frequency of the first specific block.

18. A storage apparatus, comprising:
a first storage unit;
a second storage unit, coupled to the first storage unit; and
a control unit, coupled to the first storage unit and the second storage unit, the control unit comprising:
a first processing circuit, for controlling data access to the storage apparatus; and
a second processing circuit, while the first processing circuit stores an input data into the first storage unit, for checking whether the input data has continuity; if the input data has continuity, the first processing circuit stores a portion of the input data that has not been stored into the first storage unit into the first storage unit, and if the input data does not have continuity, the first processing circuit stores the portion of the input data that has not been stored into the first storage unit into the second storage unit.

19. The storage apparatus of claim 18, wherein the first storage unit is a multi-level cell storage unit and the second storage unit is a single-level cell storage unit.

20. The storage apparatus of claim 18, wherein the storage apparatus is a solid state disk, and the first and the second storage unit are flash memories.
